(19) United States
(12) Patent Application Publication
(10) Pub. No.: US 2018/0240198 A1
(43) Pub. Date: Aug. 23, 2018

(54) METHOD FOR TRANSACTING TAX RELATED DATA

(71) Applicant: Zishun Michael Chen, City of Industry, CA (US)

(72) Inventor: Zishun Michael Chen, City of Industry, CA (US)

(21) Appl. No.: 15/697,363

(22) Filed: Sep. 6, 2017

Related U.S. Application Data
(60) Provisional application No. 62/395,521, filed on Sep. 16, 2016.

(51) Int. Cl. G06Q 40/00; G06Q 40/02; G06Q 20/10; G06F 21/31; H04L 29/06; G06F 17/24

(52) U.S. Cl. CPC G06Q 40/123; G06Q 40/02; G06F 17/243; G06F 21/31; H04L 63/12; G06Q 20/102

(57) ABSTRACT

A method for transacting tax related data is disclosed in the present application, comprising: registering by a customer and at least one accounting means; selecting one of the at least one accounting means based on tax related needs by the customer; verifying an identity of the customer; initiating communication between the selected accounting means and the customer; providing a tax related data to the selected accounting means by the customer; reviewing the tax related data by the selected the accounting means; and submitting the tax related data by the selected accounting means.

### CROSS-REFERENCE TO RELATED APPLICATION

This application claims the priority benefit of U.S. Provisional Application Ser. No. 62/395,521, filed on Sep. 16, 2016. The entirety of the above-mentioned patent application is hereby incorporated by reference herein and made a part of this specification.

### TECHNICAL FIELD OF THE INVENTION

The present invention relates generally to a method for transacting tax related data, and more particularly, to a method for transacting tax related data between a customer and an accounting means.

### BACKGROUND OF THE INVENTION

Those skilled in the art will recognize that tax preparation and filing is a complex and iterative process which requires thorough understanding of tax laws, customer specific situation as well as time. Typically, a customer has two options to meet Internal Revenue Service tax filing obligations. The customer can either preparing tax returns using online software, or to seek the services of a professional tax preparer for completing this process. When the customer utilizes software to prepare the tax returns; the software is typically a software product available online or as in a standalone form such as in a CD.

Although the software option eliminates the need to spend time and effort in travelling to meet a tax preparer, it does not simplify the customer's experience in preparing the tax returns. Most of the times, a customer comes across uncertain tax situation, to which the online software is not able to answer satisfactorily. Further, the customer has to pay to buy the software or have a subscription to avail these facilities. This set up makes the process further complicated and time consuming.

In addition, in order to ask a question, a taxpayer has to be first aware that there is an issue with the tax position they have taken for either reporting income or taking a deduction. In many instances, the taxpayer is not adequately aware of the tax regulation to even realize that there is a problem that requires consulting with a tax professional until they are audited, and then the search for professional help is too late.

### SUMMARY OF THE INVENTION

The present application discloses a method for transacting tax related data for enabling a customer and an accounting means to access, import, export, edit, and share tax related data in real time for generating tax related reports, generating financial statements, calculating tax returns, reviewing and signing off on tax returns, asking tax related questions, participating in tax related audits, and other tax related processes and uses.

The method for transacting tax related data comprises registering by a customer and at least one accounting means; selecting one of the at least one accounting means based on tax related needs by the customer; verifying an identity of the customer; initiating communication between the selected accounting means and the customer; providing a tax related data to the selected accounting means by the customer; reviewing the tax related data by the selected the accounting means; and submitting the tax related data by the selected accounting means.

In various exemplary embodiments, the step of registering by the customer and the at least one accounting means comprises registering via a customer interface by the customer. The step of initiating communication between the selected accounting means and the customer comprises communicating with the selected accounting means via an interaction interface of the customer interface by the customer.

In various exemplary embodiments, the step of registering by the customer and the at least one accounting means comprises registering via a customer interface by the customer. The step of providing the tax related data to the selected accounting means by the customer comprises submitting the tax related data to the selected accounting means via a tax filing interface of the customer interface.

In various exemplary embodiments, the step of registering by the customer and the at least one accounting means comprises registering via a customer interface by the customer. The step of providing the tax related data to the selected accounting means by the customer comprises e-signing via a tax filing interface of the customer interface.

In various exemplary embodiments, the step of registering by the customer and the at least one accounting means comprises registering via a customer interface by the customer. The step of providing the tax related data to the selected accounting means by the customer comprises paying a required fee for the selected accounting means via a tax filing interface of the customer interface. In addition, the step of paying the required fee for the selected accounting means via the tax filing interface of the customer interface comprises depositing check via the tax filing interface of the customer interface.

In various exemplary embodiments, the step of registering by the customer and the at least one accounting means comprises registering via a customer interface by the customer. After submitting the tax related data by the selected accounting means, the method further comprises notifying the customer that a tax related service or product is at least partially completed by the selected accounting means; and reviewing the at least partially completed tax related service or product via a review data interface of the customer interface by the customer.

In various exemplary embodiments, wherein the step of registering by the customer and the at least one accounting means comprises registering via an accountant interface by the at least one accounting means. The step of initiating communication between the selected accounting means and the customer comprises communicating with the customer via an interaction interface of the accountant interface by the selected accounting means.

In various exemplary embodiments, wherein the step of registering by the customer and the at least one accounting means comprises registering via an accountant interface by the at least one accounting means. The step of reviewing the tax related data by the selected accounting means comprises reviewing via a reviewing interface of the accountant interface by the selected accounting means.

In various exemplary embodiments, after the step of verifying the identity of the customer, the method further comprises sending a verification code for the customer by the selected accounting means; and submitting the verification code by the customer.

In various exemplary embodiments, after reviewing the tax related data by the selected accounting means, the method further comprises requesting an additional tax related data from the customer by the selected accounting means; and providing the additional tax related data to the selected accounting means by the customer.

In various exemplary embodiments, the customer is an individual, a household or a corporation.

In various exemplary embodiments, the at least one accounting means is a bookkeeper, a tax specialist, a tax attorney or an accounting firm.

In various exemplary embodiments, the tax related data includes at least one member selected from the group consisting of: payment stubs, bookkeeping records, tax returns, wages W-2, income 1099, stocks 1099-B, property taxes, deductions, home mortgage interest, and DMV registration.

Based on the above, the present application enables the customer and the accounting means to access, import, export, edit, and share tax related data in real time. The customer can search for and request tax related data, and then request tax related services or products from the accounting means through the customer interface. The accounting means may access tax related data from the customer, perform the required tax related services, and then communicate with the customer through the accountant interface. After an initial registration and verification process, the customer and the accounting means access, share, process, and finally review the tax related data through various tax related services or products offered by the accounting means. The customer and the accounting means collaborate for producing tax filings, tax notices, tax records, and preparation for audits.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 illustrates a view of an exemplary system for interacting between a customer and an accounting means.

FIGS. 2A-2B illustrate flow charts of a method for transacting tax related data.

FIGS. 3A-3C illustrate customer interfaces of an initiating procedure at the customer end.

FIGS. 4A-4D illustrate tax filing interfaces of a customer interface at the customer end.

FIG. 5 illustrates an interaction interface of the customer interface at the customer end.

FIG. 6 illustrates an accountant interface at the accounting means end.

FIG. 7 illustrate a review data interface of the customer interface at the customer end.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

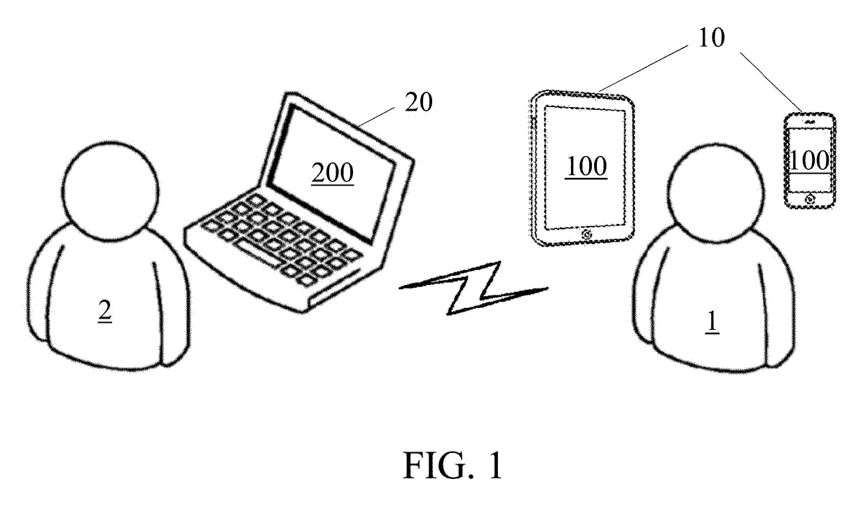

FIG. 1 illustrates a view of an exemplary system for interacting between a customer 1 and an accounting means 2.

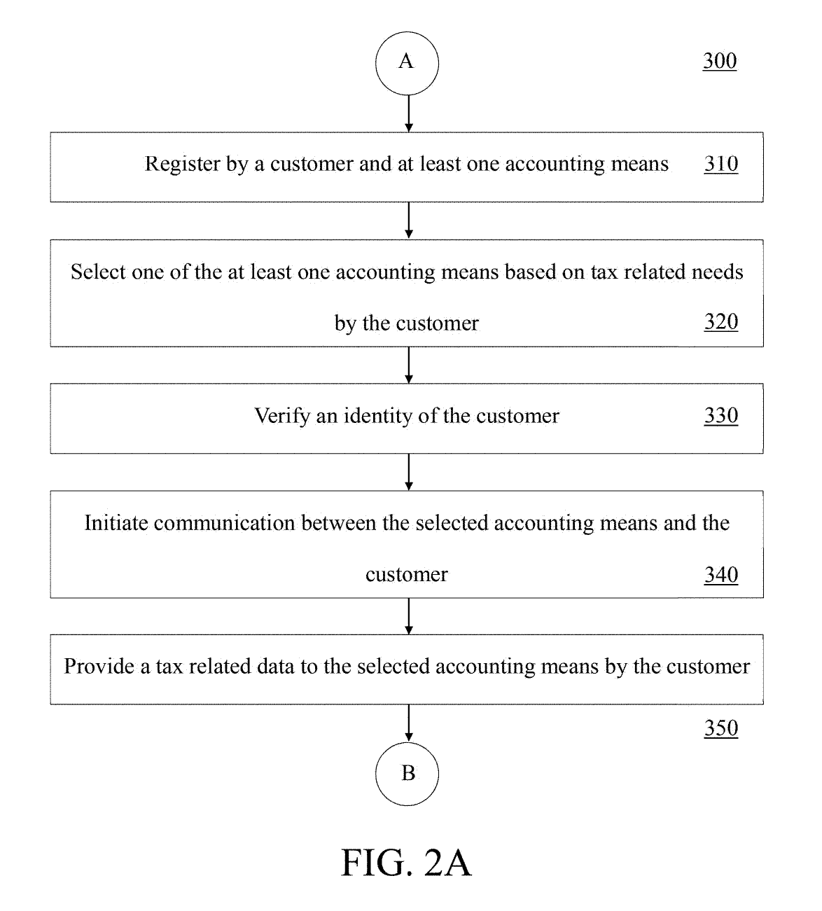

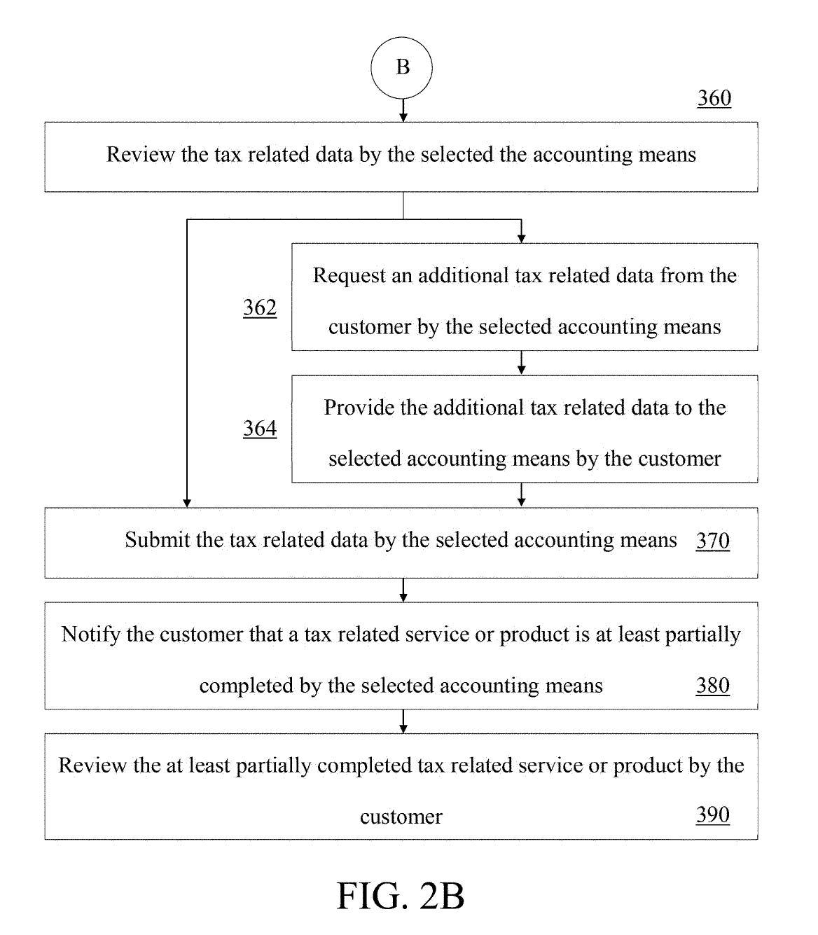

Referring to FIG. 1, a method 300 (referring to FIG. 2A) for transacting tax related data between a customer 1 and an accounting means 2 is disclosed in the present application. Specifically, the customer 1 may utilize a mobile device 10 such as portable tablet, a smartphone or a public processor to interact with the accounting means 2. Meanwhile, the accounting means 2 may also communicate with the customer 1 via mobile device 20 such as computer or laptop.

It should be noted that the customer 1 here may be an individual, a household or a corporation, the present application is not limited. In addition, the accounting means 2 may be a bookkeeper, a tax specialist, a tax attorney or an accounting firm as long as the accounting means 2 has the ability to prepare, review, edit or submit the required documentation, the present application is not limited. Furthermore, the tax related data may be payment stubs, bookkeeping records, tax returns, wages W-2, income 1099, stocks 1099-B, property taxes, deductions, home mortgage interest, and DMV registration. However, the present application is not limited, the tax related data may be any kind of documentation as long as tax related needs are required by customer 1.

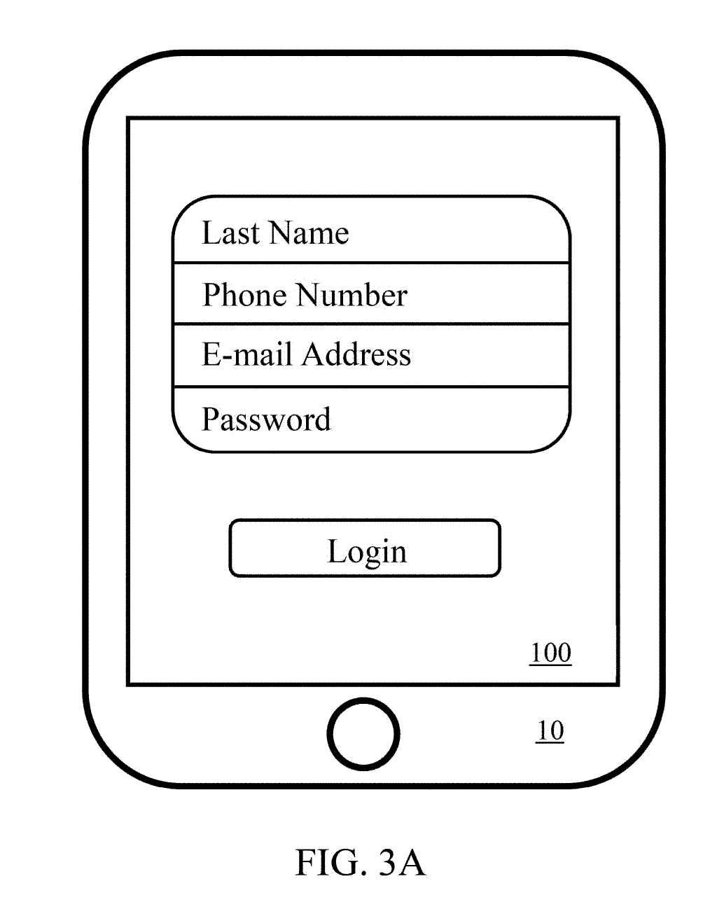

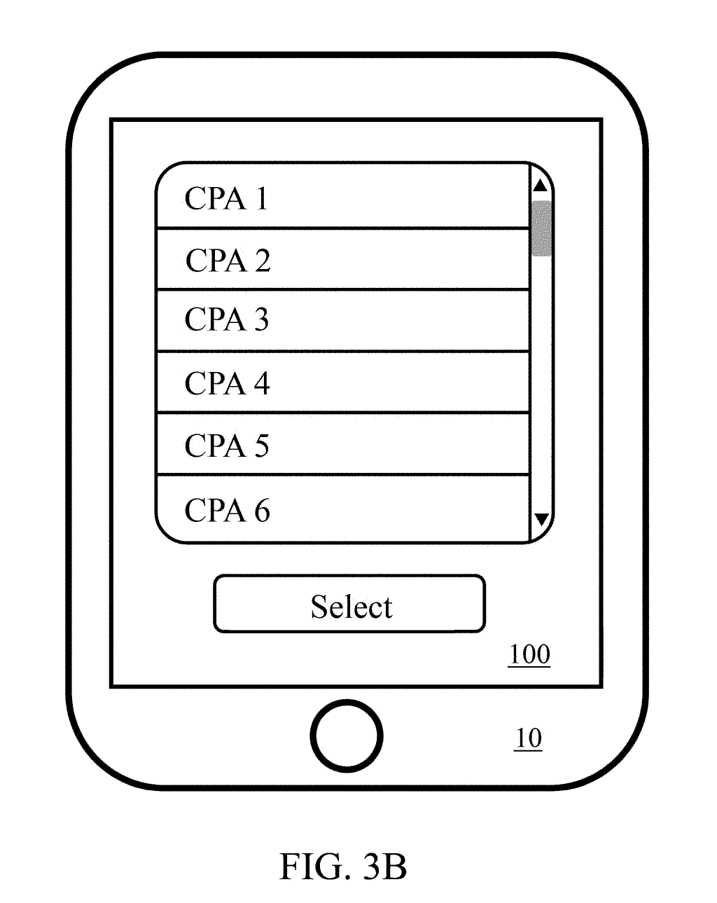

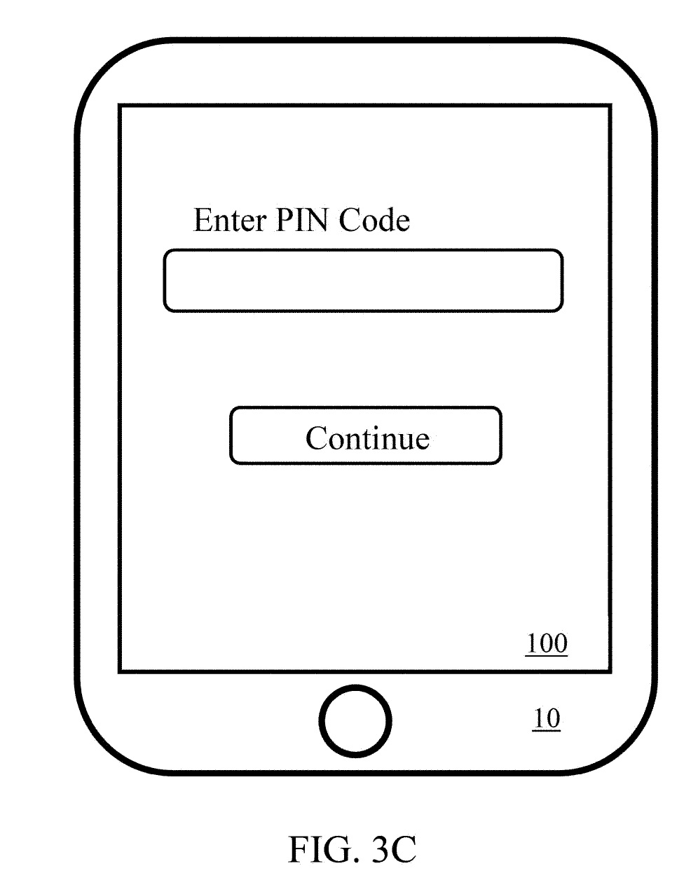

FIGS. 2A-2B illustrate flow charts of a method for transacting tax related data. FIGS. 3A-3C illustrate customer interfaces 100 of an initiating procedure from the customer 1 end.

As shown in FIGS. 2A-3C with reference to FIG. 1, the present application discloses the method 300 for transacting tax related data, comprising registering by the customer 1 and at least one accounting means 2 as shown in step 310. Specifically, both the customer 1 and the accounting means 2 should register before interacting with each other. Referring to FIG. 2A, the customer 2 may register via a customer interface 100 of the mobile device 2. The customer interface 100 may comprise any kind of personal information such as name, phone number, SSN, email address or password for login or registration, the present application is not limited.

After registration, the customer 1 then select one of accounting means based on his/her tax related needs as shown in step 320. In detail, the customer can choose the required accounting means via the customer interface 100, which may show a list of registered accounting means. For example, as shown in FIG. 2B, the list of certified public accountant (CPA) is shown on the customer interface 100 for selection.

As shown in FIG. 3C, a confirmation interface is popped up after the selection. Specifically, the selected accounting means 2 will send a verification code for the customer 1 after confirming the request from the customer 1. As shown in step 330, the customer 1 then may submit the verification code to verify his/her identity. As shown in step 340, the communication between the selected accounting means 2 and the customer 1 is initiated after verifying the identity of the customer 1.

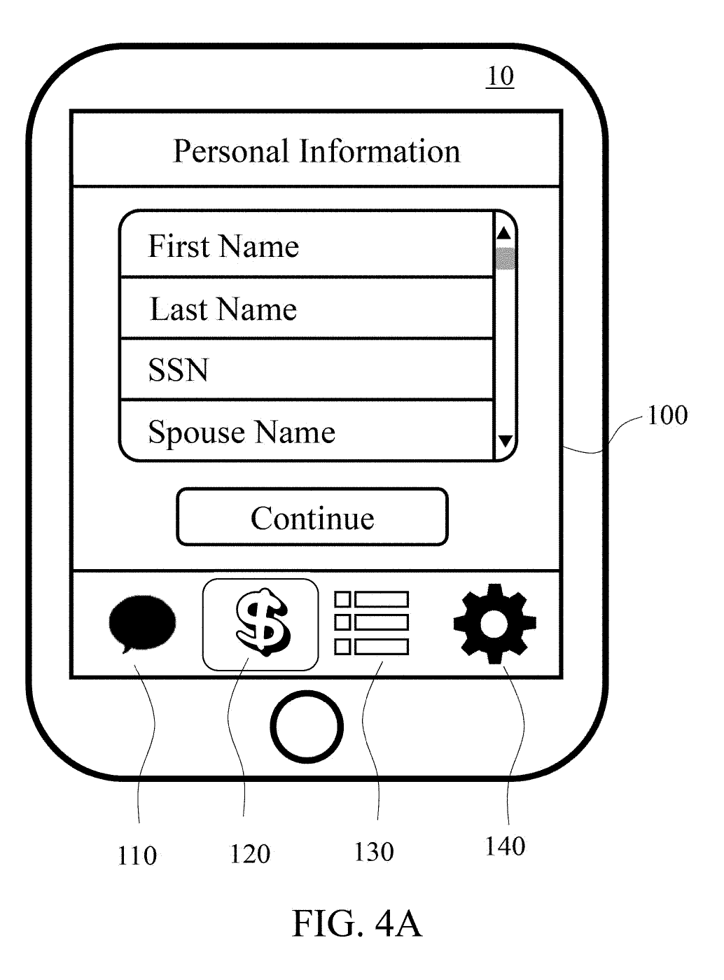

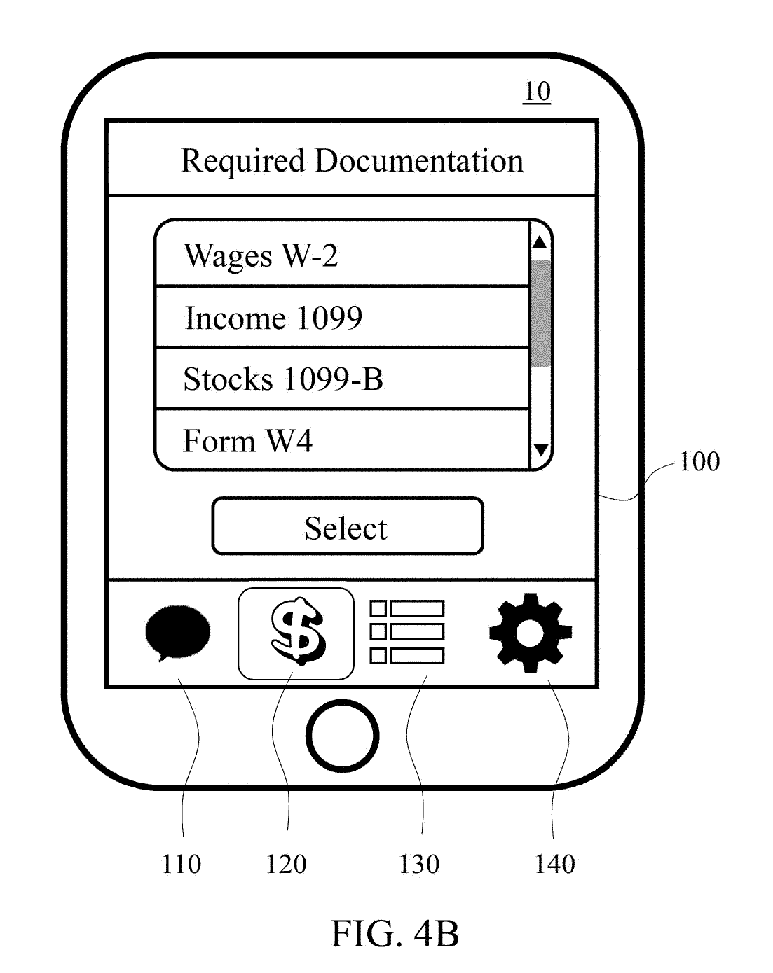

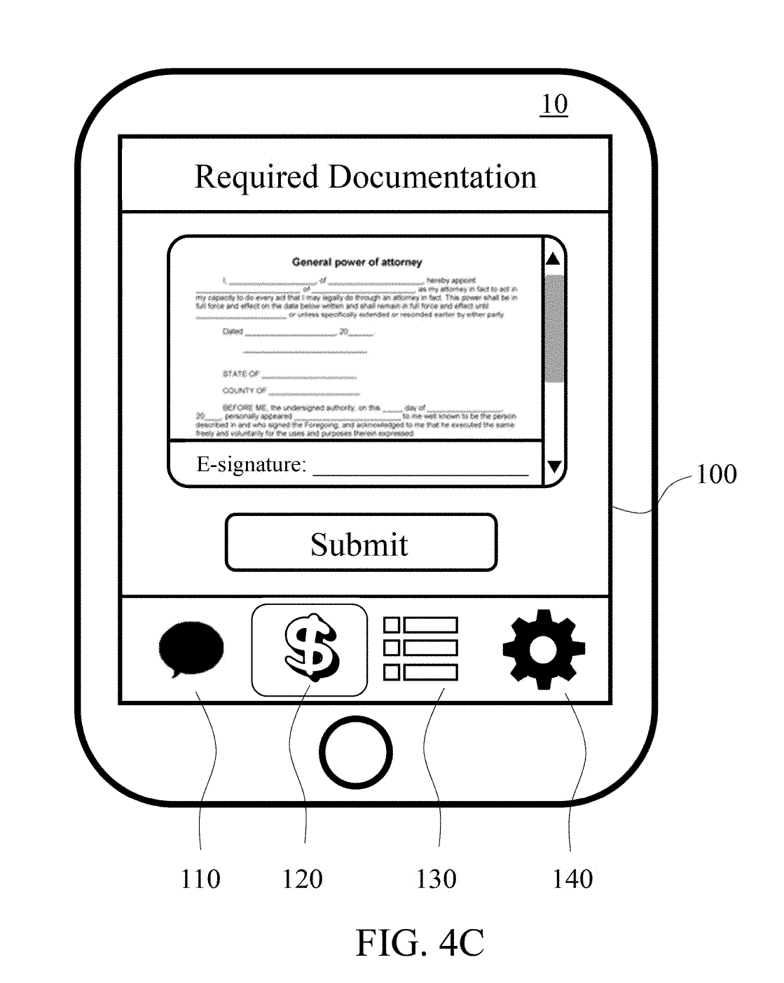

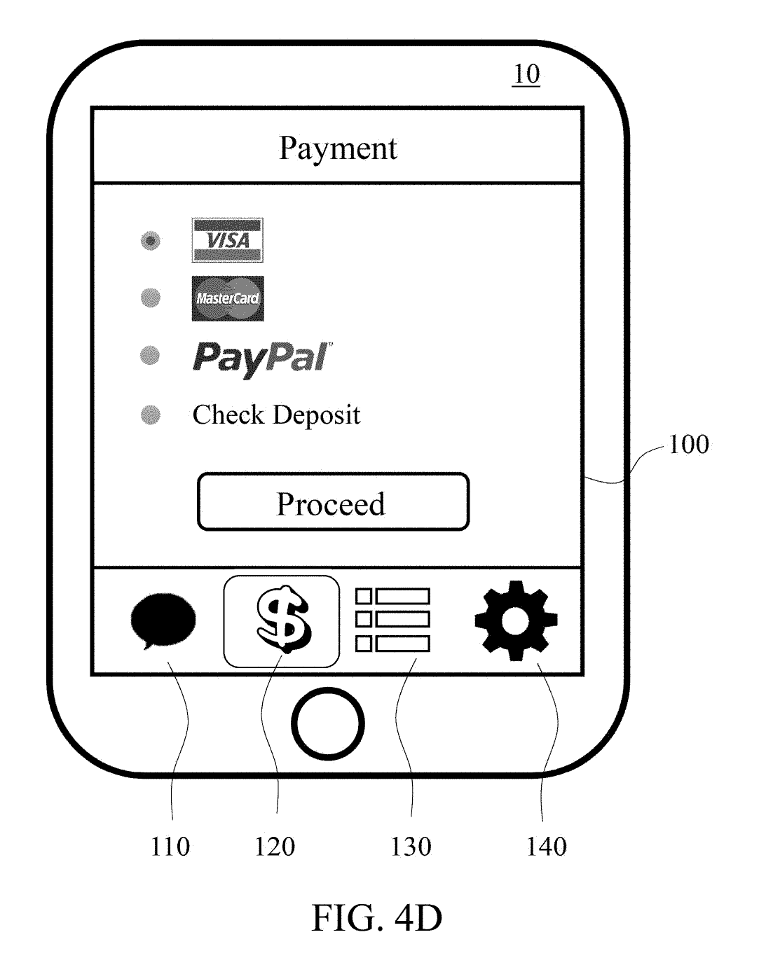

FIGS. 4A-4D illustrate the tax filing interfaces 120 of the customer interface 100 from the customer 1 end.

As shown in FIGS. 2A-2B and FIGS. 4A-4D with reference to FIG. 1, after submitting the verification code by the customer 1, a selectable interface will be popped up. Specifically, the customer interface 100 comprises an interaction interface 110, a tax filing interface 120, a review data interface 130 and a setting interface 140. As shown in FIGS. 4A-4C, the customer 1 may fill in required personal information, select the required documentation and e-sign via the interaction interface 110. It should be noted that the order of the figures is not limited. That is, the customer 1 may select the required documentation before or after fill in the personal information, or e-sign document such as power of attorney contract before or after fill in the personal information. After the customer 1 has already prepared the tax related data, as shown in step 350, then provide the tax related data to the selected accounting means 2.

In addition, the way for e-signature is not limited either. The customer 1 may set a pin code in advance to authenticate their signature. Specifically, the accounting means 2 will predefine the signing location on document. Once the customer 1 review and agree with documents, the customer interface 100 will prompt a pin code request for the customer 1 to enter. If an input pin code matches the pin code set by the customer 1, the system will automatically affix a pre-saved handwritten signature on the document. Therefore, the customer 1 no longer need to cruise around and look for the spot to sign.

As shown in FIG. 4D, the customer 1 can pay a required fee for the selected accounting means 2 via the tax filing interface 120 of the customer interface 100 after providing the tax related data to the selected accounting means 2. The payment methods may be paying by debit card, credit card, PayPal or check deposit, the present application is not limited by the method of payment. It should be noted that if the customer 1 chooses to pay the required fee by depositing check, the tax filing interface 120 will show a photo interface allowing the customer 1 to take picture for the front/back side of the check.

It should be noted that, during this procedure, the customer 1 may contact with the accounting means 2 anytime when he/she needs help.

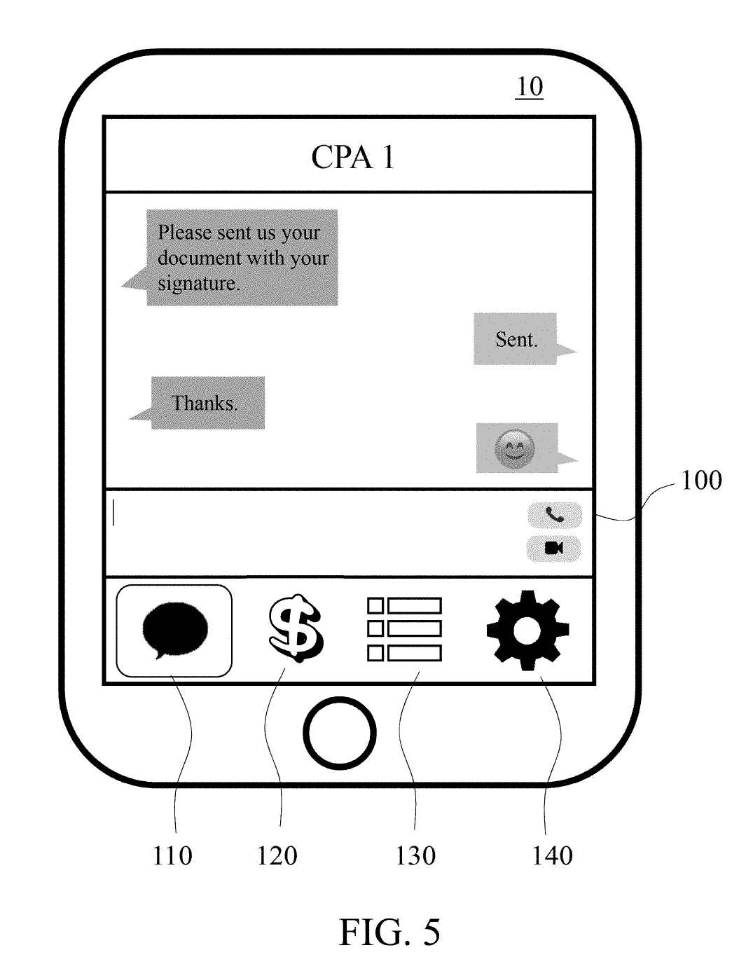

FIG. 5 illustrates the interaction interface 110 of the customer interface 100 from the customer 1 end.

As shown in FIG. 5, the customer 1 can communicate with the selected accounting means 2 via the interaction interface 110 of the customer interface 100. In addition, the customer 1 may also call or have face time with the accounting means 2 via the interaction interface 110 as well.

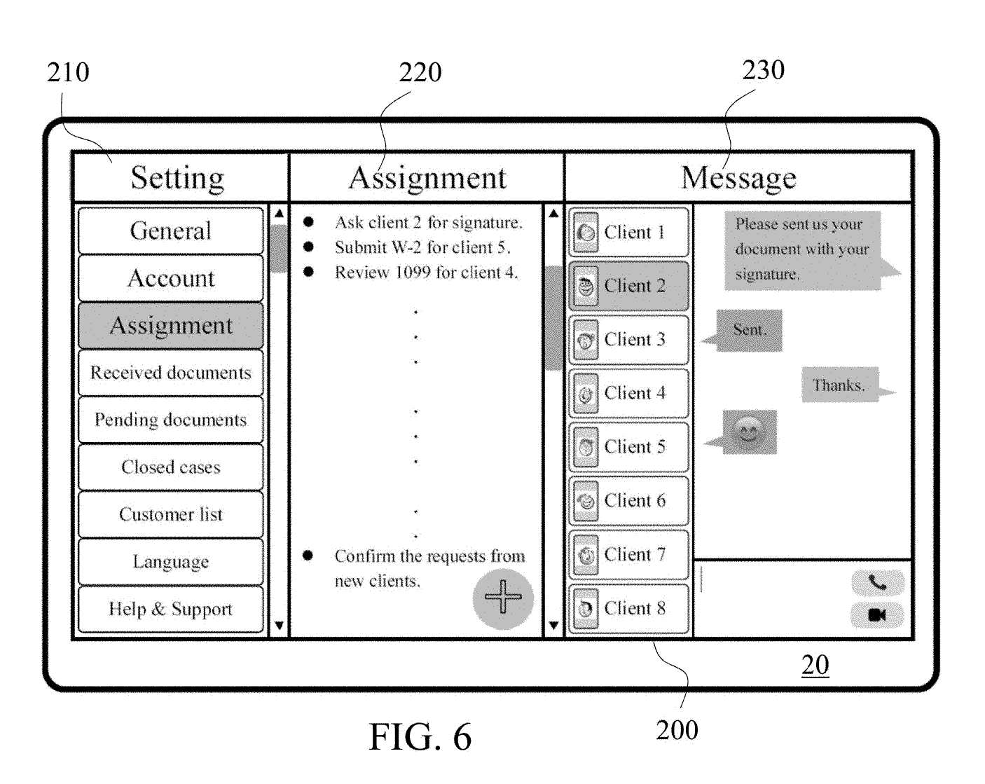

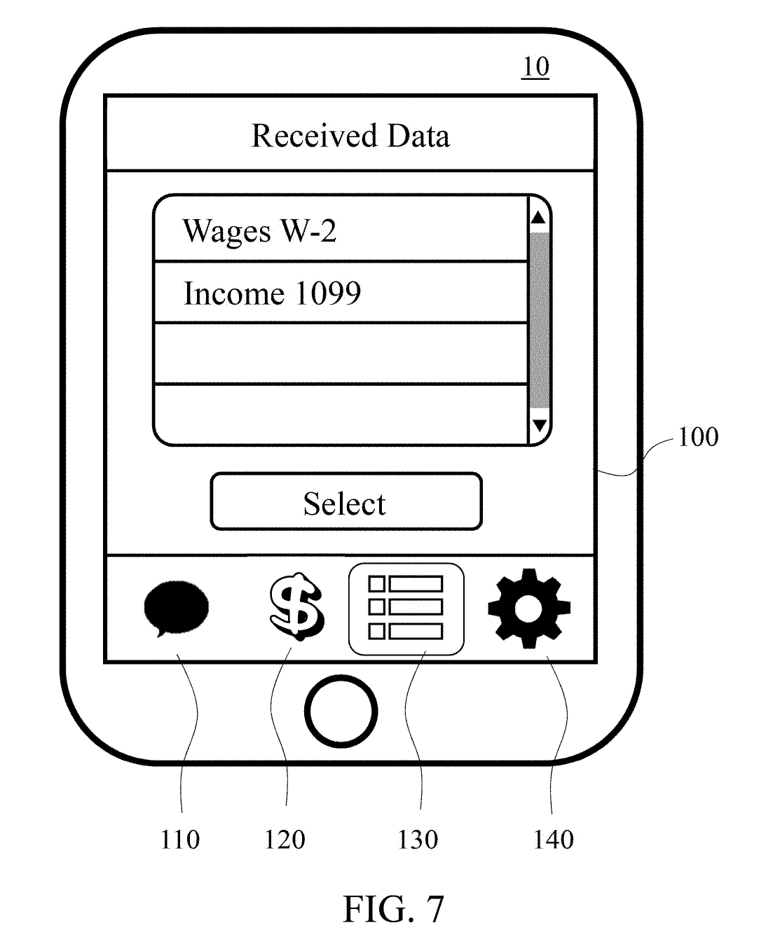

FIG. 6 illustrates an accountant interface 200 at the accounting means 2 end. FIG. 7 illustrate a review data interface of the customer interface at the customer end.

Referring to FIGS. 6-7, the accountant interface 200 comprises a setting interface 210, an operating interface 220 and an interaction interface 230. As shown in step 360, after the customer 1 provide the tax related data, the accounting means 1 then further reviews the tax related data. Specifically, the setting interface 210 has many options for choosing the required options by the accounting means 1. In addition, the content of the option may be shown on the operating interface 220. For example, the option of assignment lists the to do list for the accounting means 2. In addition, thought it does not show in the figure specifically, the accounting means 1 may also review the received documents on the operating interface 220.

As shown in step 362 and step 364, the accounting means 2 may request an additional tax related data from the customer 1 if something is missed. The customer 1 then may prepare and provide the additional tax related data to the accounting means 2 after receiving the notification. The interaction and communication between the customer 1 and the accounting means 2 may be proceeded via the interaction interface 110 (referring to FIG. 5) of the customer interface 100 (referring to FIG. 5) and the interaction interface 230 of the accountant interface 200.

After confirming the required and received documents, the accounting means 2 then submit the tax related data to the specific agency such as Internal Revenue Service as shown in step 370. It should be noted that the accounting means 2 may send all confirmed documents back to the customer 1 for further confirmation, and may also submit all confirmed documents directly without the confirmation of the customer 1 under the authority of the customer 1.

As shown in step 380, the accounting means 2 then notify the customer 1 that a tax related service or product is at least partially completed after submit the tax related data. The tax related service or product here may be generating tax related reports, generating financial statements, calculating tax returns, reviewing and signing off on tax returns, asking tax related questions, participating in tax related audits, compiling bookkeeping data, and performing other tax related processes and uses, the present application is not limited thereto as long as the tax related service or product meet the needs of the customer 1.

Referring to FIG. 7 and step 390, the customer 1 then may review the at least partially completed tax related service or product via the review data interface 130 of the customer interface 100.

It should be noted that the customer 1 may utilize the system for processing documents beyond taxes, including loans, insurance, and investments. In these cases, the accounting means 2 may be a bank, an insurance company or an investment company, and the customer may collaborate with a banker, an insurance agent or an investment broker, respectively.

In addition, the customer 1 and the accounting means 2 may also have power to authorize to third parties for viewing. Specifically, the third parties such as the bank, the insurance company or the investment company may need some personal information from the customer 1. In this case, the customer 1 and the accounting means 2 may authorize, either partially or fully, the third parties to have access to view the tax-related data. For partial authorization, the customer 1 and the accounting means 2 may decide which data is authorized for viewing. However, the present application is not limited between the customer 1 and the accounting means 2. Specifically, the customer 1 may also need to share his/her personal information with additional third parties. In the case that at least two parties are willing to share the same personal information, a social network tab may be further configured on the customer interface 100 and the accountant interface 200 correspondingly. All interested parties will be listed on the customer interface 100 and the accountant interface 200 for future communication after clicking the social network tab. They can communicate as a group comprising any interested parties such as CPA, business partners, loan agent, lawyer, insurance agent or family members.

Based on the above, the method for transacting tax related data between the customer and the accounting means provides a software platform that delivers computer implemented, web accessible tax related services or products. It enables the customer and the accounting means to efficiently access, import, export, edit, and share the tax related data in real time. Specifically, the customer interface and accountant interface enable the customer to search for and request tax related data and then request a tax related service or product from the accounting means. The accounting means then may access tax related data from the customer, perform the required tax related service or product, and then communicate the results with the customer.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A method for transacting tax related data, comprising:
registering by a customer and at least one accounting means;
selecting one of the at least one accounting means based on tax related needs by the customer;
verifying an identity of the customer;
initiating communication between the selected accounting means and the customer;
providing a tax related data to the selected accounting means by the customer;
reviewing the tax related data by the selected the accounting means; and
submitting the tax related data by the selected accounting means.

2. The method for transacting tax related data as claimed in claim 1, wherein the step of registering by the customer and the at least one accounting means comprises registering via a customer interface by the customer.

3. The method for transacting tax related data as claimed in claim 2, wherein the step of initiating communication between the selected accounting means and the customer comprises communicating with the selected accounting means via an interaction interface of the customer interface by the customer.

4. The method for transacting tax related data as claimed in claim 2, wherein the step of providing the tax related data to the selected accounting means by the customer comprises submitting the tax related data to the selected accounting means via a tax filing interface of the customer interface.

5. The method for transacting tax related data as claimed in claim 2, wherein the step of providing the tax related data to the selected accounting means by the customer comprises e-signing via a tax filing interface of the customer interface.

6. The method for transacting tax related data as claimed in claim 2, wherein the step of providing the tax related data to the selected accounting means by the customer comprises paying a required fee for the selected accounting means via a tax filing interface of the customer interface.

7. The method for transacting tax related data as claimed in claim 6, wherein the step of paying the required fee for the selected accounting means via the tax filing interface of the customer interface comprises depositing check via the tax filing interface of the customer interface.

8. The method for transacting tax related data as claimed in claim 2, wherein after submitting the tax related data by the selected accounting means, the method further comprises notifying the customer that a tax related service or product is at least partially completed by the selected accounting means.

9. The method for transacting tax related data as claimed in claim 8, wherein after notifying the customer that the tax related service or product is at least partially completed by the selected accounting means, the method further comprises reviewing the at least partially completed tax related service or product by the customer.

10. The method for transacting tax related data as claimed in claim 9, wherein the step of reviewing the at least partially completed tax related service or product by the customer comprises reviewing via a review data interface of the customer interface.

11. The method for transacting tax related data as claimed in claim 1, wherein the step of registering by the customer and the at least one accounting means comprises registering via an accountant interface by the at least one accounting means.

12. The method for transacting tax related data as claimed in claim 11, wherein the step of initiating communication between the selected accounting means and the customer comprises communicating with the customer via an interaction interface of the accountant interface by the selected accounting means.

13. The method for transacting tax related data as claimed in claim 11, wherein the step of reviewing the tax related data by the selected accounting means comprises reviewing via a reviewing interface of the accountant interface by the selected accounting means.

14. The method for transacting tax related data as claimed in claim 1, wherein after the step of verifying the identity of the customer, the method further comprises sending a verification code for the customer by the selected accounting means.

15. The method for transacting tax related data as claimed in claim 14, wherein after the step of sending a verification code for the customer by the selected accounting means, the method further comprises submitting the verification code by the customer.

16. The method for transacting tax related data as claimed in claim 1, wherein after reviewing the tax related data by the selected accounting means, the method further comprises requesting an additional tax related data from the customer by the selected accounting means.

17. The method for transacting tax related data as claimed in claim 16, wherein after requesting the additional tax related data from the customer by the selected accounting means, the method further comprises providing the additional tax related data to the selected accounting means by the customer.

18. The method for transacting tax related data as claimed in claim 1, wherein the customer is an individual, a household or a corporation.

19. The method for transacting tax related data as claimed in claim 1, wherein the at least one accounting means is a bookkeeper, a tax specialist, a tax attorney or an accounting firm.

20. The method for transacting tax related data as claimed in claim 1, wherein the tax related data includes at least one member selected from the group consisting of: payment stubs, bookkeeping records, tax returns, wages W-2, income 1099, stocks 1099-B, property taxes, deductions, home mortgage interest, and DMV registration.
